(19) United States
(12) Patent Application Publication
(10) Pub. No.: US 2006/0070217 A1
(43) Pub. Date: Apr. 6, 2006

(54) Hydroentanglement screen

(75) Inventor: Ian Christison Sayers, Lancashire (GB)

Correspondence Address: GREENBLUM & BERNSTEIN, P.L.C., 1950 ROLAND CLARKE PLACE, RESTON, VA, 20191, US

(73) Assignee: Voith Fabrics Patent GmbH, Heidenheim (DE)

(21) Appl. No.: 10/535,836

(22) PCT Filed: Nov. 21, 2003
(86) PCT No.: PCT/EP03/13294

§ 371 Date: Aug. 31, 2005

(30) Foreign Application Priority Data
Nov. 21, 2002 (GB) 0227158.3

(51) Int. Cl. D04H 5/02; D04H 1/46; D04H 1/70; B29C 70/22

(52) U.S. Cl. 28/104; 28/103; 28/106; 28/169

(57) ABSTRACT

A method of producing a screen for forming a nonwoven material by hydroentanglement. The method includes the steps of providing a layer of radiation curable polymeric resin material in fluid form. Further, the step of irradiating at least one layer of radiation curable polymeric resin material in fluid form through at least one mask selectively transparent to the radiation, so as to effect at least partial curing of the material of the at least one layer in positions corresponding with radiation-transparent regions of the mask. Further still, the step of removing uncured polymeric material to form one or more apertures within the at least one layer. Wherein the radiation-transparent regions of the mask have different sizes and shapes and are distributed randomly, such that the one or more apertures provided in the cured polymeric material of the screen are not provided in a regular pattern or form.

### CROSS-REFERENCE TO RELATED APPLICATIONS

The present application claims priority under 35 U.S.C. §119 and 365 based upon Great Britain Application No. 0227158.3, filed Nov. 21, 2002, the disclosure of which is expressly incorporated by reference herein in its entirety.

### BACKGROUND OF THE INVENTION

1. Field of the Invention

The present invention relates to a hydroentanglement screen in the form of a porous belt, for manufacturing a nonwoven material by hydroentangling a fibrous web and a method of manufacturing such a screen.

2. Discussion of Background Information

The hydroentanglement process for manufacturing nonwoven webs is well known, for example from CA 841938. The process involves directing a series of water jets towards a fibrous web that is supported on a moving porous belt. The water jets pass downwards through the mass of fibers and upon making contact with the surface of the belt, the jets rebound, and break up, such that the energy released causes entanglement of the mass of fibers.

The porous belt or “wire” used to support the fibrous web during the hydroentanglement process is conventionally a woven structure. The woven structure does not have a planar web-support surface, but instead possesses a series of knuckles as each yarn passes above and then below other yarns within the weave structure.

These knuckles tend to mark the nonwoven web forming an imprint in the web which is an undesirable or negative weave pattern of the wire. More critical though, is the need to break up the series of parallel lines presently formed in hydroentangled products, due to the geometrically regular nature of the woven fabric.

Further, problems arise from using woven wires such as the difficulty in removing the hydroentangled web from the wire due to fibers being captured between warp and weft yarns at their crossover points. These fibers are difficult to remove from the wire during the cleaning process after a hydroentangled product has been formed on the wire.

WO01/88261 AI describes a close-meshed screen molded from a thermoplastic material for forming hydroentangled nonwoven products. The screen comprises a series of regularly spaced cells of uniform dimensions, and appears to suggest groups of apertures of different sizes may be arranged to form specific patterns in the nonwoven end-product. The regular pattern of apertures in the belts of WO01/88261 expressly causes marking in the hydroentangled end-product. Such patterning can be achieved through the use of woven fabrics, but the problem of the fiber web release is still, manifest. This problem does not occur when the close-meshed screen is deployed.

WO 91/14558 is concerned with papermaking belts as opposed to hydroentanglement screens. Here a perforate structure is made from photopolymeric resin material over which a mask is used to shield parts of the resin from a U. V. radiation source. Further, the shielded parts of the resin are not cured and the uncured resin is then washed away. Further still, the sheet material formed as mentioned above is perforate.

WO 02/20900 AI describes a papermaker's belt in which a patterned framework is located on a woven reinforcing element, wherein a framework forms an impression on the paper transported on the belt.

### SUMMARY OF THE INVENTION

The present invention provides a screen, such as a porous belt, for use in the manufacture of hydroentanglement products which does not mark the hydroentangled products with a geometrically regular pattern of lines resulting from an imprint by a woven screen, as such regular patterns tend to be perceptible to the consumer.

According to the present invention, the invention provides a method of producing a screen on which a nonwoven material may be formed by hydroentanglement. The method includes providing for a layer of radiation curable polymeric resin material in fluid form, irradiating the layer of material through a mask selectively transparent to the radiation so as to effect at least partial curing of the material of the layer in positions corresponding with radiation-transparent regions of the mask. The invention further provides for removing uncured polymeric material and effecting any necessary subsequent full cure of the residual material, wherein the radiation-transparent regions of the mask have various sizes and shapes and are distributed randomly, such that apertures provided in the cured polymeric material of the screen are not provided in a regular pattern or form.

According to another aspect of the invention, a mask is used for the manufacture of a screen, as previously defined, wherein the mask has radiation-transparent regions having various sizes and shapes, which are distributed randomly in the mask.

According to another aspect of the invention, a hydroentanglement screen on which a nonwoven material can be manufactured by hydroentanglement, provides an array of apertures in the surface of the screen on which the nonwoven material is manufactured. Further, the array of apertures can be of various sizes and shapes and be distributed randomly such that the apertures are not provided in a regular pattern. A computer program may randomly determine the size, shape and disposition of the various individual apertures during manufacture of the screen or mask, such that no repeat pattern is perceptible.

As hydroentanglement screens are generally in the form of belts it is desirable to provide additional strength in the machine-direction of the belt. Consequently, the resin can be applied as a coating on a base fabric. The resin may at least partially impregnate the base fabric. The base fabric may be woven. The thickness of such coating layers would generally be in the range from 200 μm to 500 μm. This coating would effectively remove the problems associated with knuckles in any woven fabric used as the base material, such that the knuckles would not protrude through the coating.

In an alternative embodiment of the invention, a row of machine direction yarns may extend through the screen to provide strength. In particular, the thickness of the screen would generally be in the region from 0.8 mm to 1.5 mm.

The apertures may have any shape. The width of the apertures can be in the range from 100 μm to 800 μm. The apertures may constitute 50% to 70%, and may substantially be 60% of the surface area of the screen. Although the apertures are randomly distributed, the aggregate porosity per unit area may approximately be the same or approximately similar. Large porosity differences should not exist across the screen.

The resin may be cured by ultra-violet radiation. The resin may comprise of at least one urethane acrylate, preferably a difunctional aromatic urethane acrylate. One such material is provided by Akcros Chemicals under the trademark PHOTOMER 6052. This material is a difunctional aromatic urethane acrylate based on a relatively long chain polyether polyol. Such a resin may be used in combination with other acrylate resins, for example acrylated epoxy resins, to impart flexibility and to promote cure.

The mask used in the manufacture of the screen would generally comprise a plastics material, typically an acetate film, which is transparent to ultra-violet light. This could be printed with a plurality of isolated ink dots of various sizes and shapes, the dots being arranged randomly on the plastics base material. The mask would generally be provided as a flexible endless belt or sheet.

According to the invention, a second layer of radiation curable material may be applied and parts of it cured, in a like manner to that previously described. For example, a desired pattern of desired shapes can be provided on the surface of the screen formed as previously described, so as not to imprint the hydroentangled product with a geometrically regular pattern of lines. Such screens, having the desired pattern of desired shapes thereon, may be used to manufacture patterned non-woven products.

### BRIEF DESCRIPTION OF THE DRAWINGS

The present invention is further described in the detailed description which follows, in which like reference numerals represent similar parts throughout the several views of the drawings, and wherein:

FIG. 1 is a perspective view of part of one hydroentanglement screen in accordance with the invention;

FIG. 2 shows in detail the apertures extending through the resin coating layer of the screen of FIG. 1;

FIG. 3 is a perspective view of part of a second hydroentanglement screen in accordance with the invention;

FIG. 4 is a diagrammatic illustration of the successive steps of the method of manufacturing the hydroentanglement screens of the invention; and

FIG. 5 is a diagrammatic view of apparatus for use in manufacturing the hydroentanglement screens of the invention.

### DETAILED DESCRIPTION OF THE PRESENT INVENTION

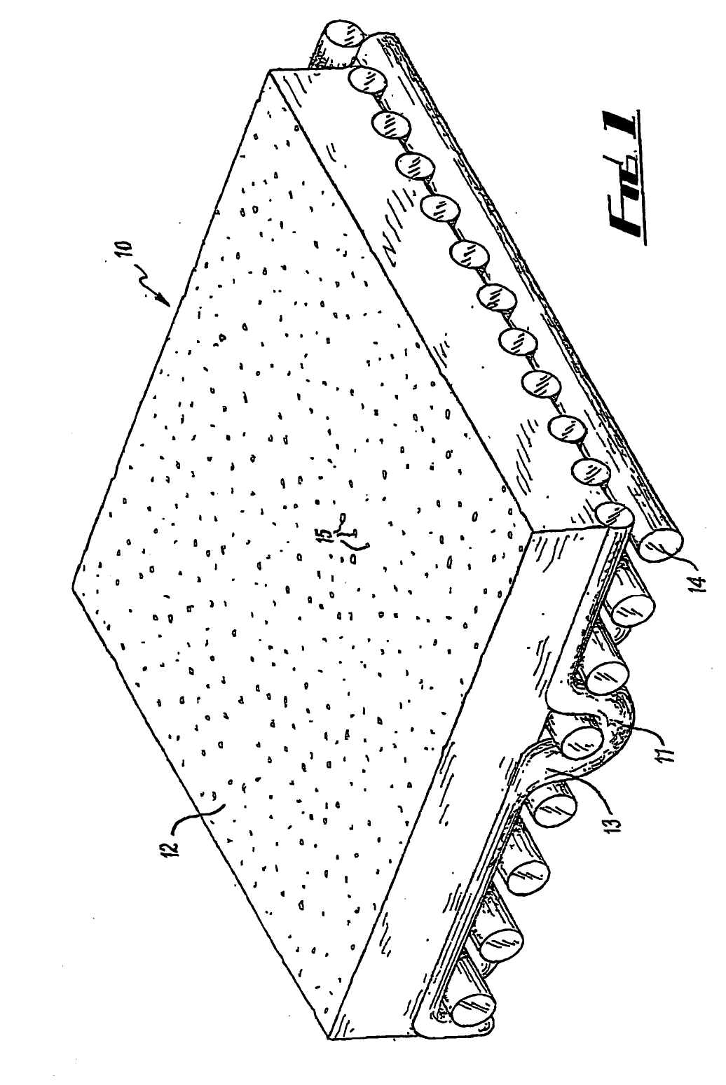

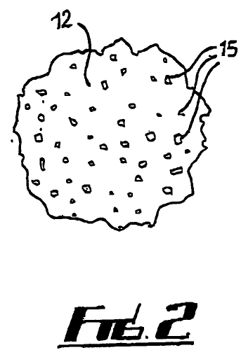

FIGS. 1 and 2 show a belt 10 (partially shown), for supporting a fibrous web during the manufacture of a nonwoven material by hydroentanglement. The belt 10 comprises a woven base layer 11 onto one face of which is coated a film of polymeric resin 12. In order to enhance the bonding of the coating layer to the yarns of the woven fabric, a tie coat, which is compatible with the polymer of the yarn and the polymeric resin, may be added to the surface of the yarn prior to applying the coating layer. Alternatively and/or additionally the woven yarns may be activated by plasma treatment at this stage in the manufacturing process to encourage covalent bonding between the woven fabric and the polymeric resin. FIG. 1 shows a woven structure in which the machine direction (MD) yarns 13 float over four cross-machine direction (CMD) yarns 14 before forming a knuckle below the fifth CMD yarn and then floating over the next four MD yarns. Both the MD yarns and CMD yarns are round in cross-section. However, flat or other shaped yarns may be used, particularly for the MD yarns.

The resin coating material 12 may include a urethane acrylate. A plurality of apertures 15 extends through this coating 12. The apertures 15 may vary in size and shape and be arranged randomly over the surface of the coating 12, as viewed in FIG. 2.

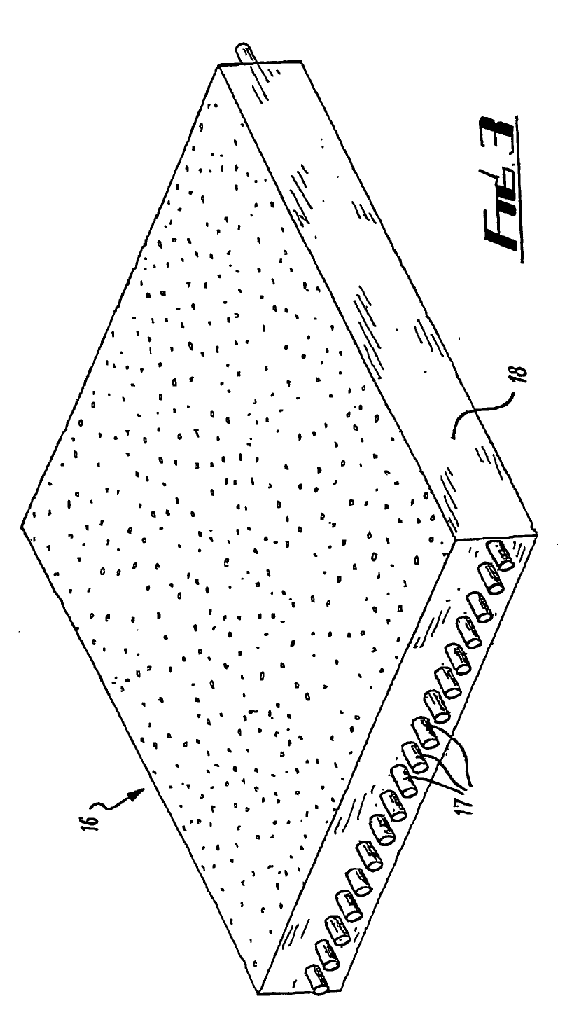

FIG. 3 shows an alternative embodiment of hydroentanglement screen 16 in accordance with the invention. In particular, a row of parallel monofilament or multifilament yarns 17 extends through a urethane acrylate layer 18, so as to provide structural strength in the running direction of those yarns. An array of apertures extends through the U. V. cured layer 18, in a like manner to the arrangement of apertures shown in FIG. 1.

The hydroentanglement screens 10, 16 as shown in FIGS. 1 and 3 are used in the manufacture of nonwoven materials, such as cleaning cloths, which may be similar to an otherwise conventional hydroentanglement process. The random distribution, size and shape of the apertures in contact with the nonwoven material of the instant invention and in comparison to the regularity of a prior art woven fabric's pattern, does not lead to any undesired, visible marking in the end product.

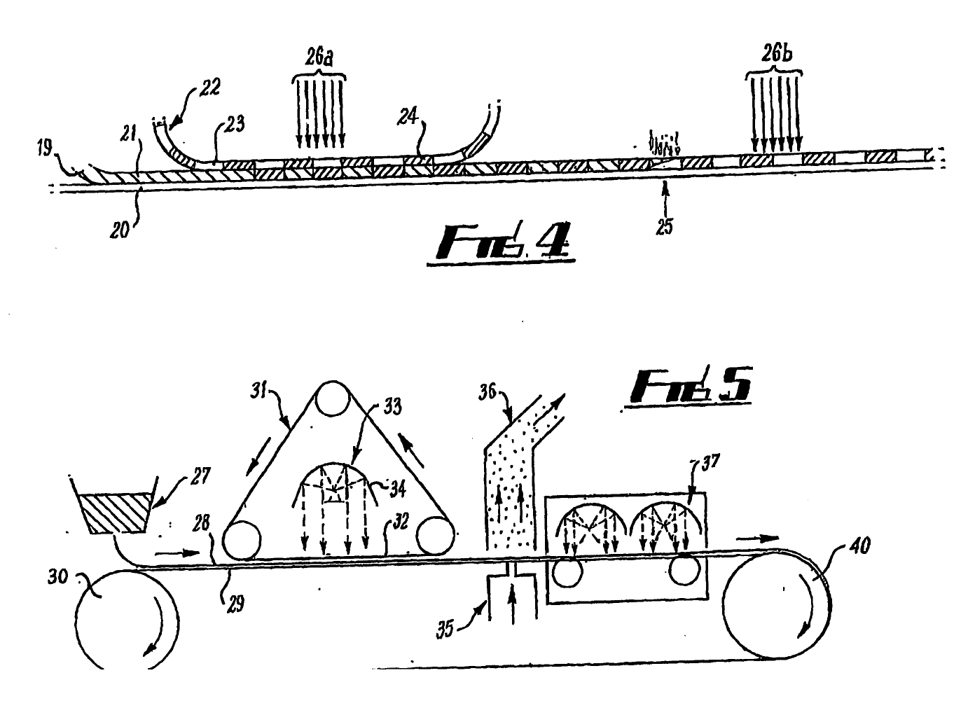

FIGS. 4 and 5 are diagrammatic illustrations showing the manufacture of screens similar to the kind illustrated in FIG. 1. FIG. 4 shows a photopolymeric resin material 19 applied to the surface of a woven base material 20, wherein the viscosity of the resin forms a layer 21 of uniform thickness thereon. A selectively transparent mask 22 is brought into close spatial relationship with respect to the upper surface of layer 21 for advancing movement therewith such that the mask 22 includes transparent and opaque regions 23, 24 respectively.

The layer 21 of resin material is subjected to illumination 26a, through the mask 22, to effect at least a partial cure of the material in locations thereof, in register with the transparent regions 23 of the mask. Further, the illumination may be in a direction normal to the surface of the mask.

After exposure to collimated U. V. radiation, the mask is moved away from the surface of the layer of photopolymeric material. The material advances toward a localized jet of pressurized air or water 25, whereby uncured polymer is removed, thus creating apertures in the partially cured layer in positions corresponding to the opaque regions of the mask.

The coated woven material is then subjected to further U. V. radiation so as fully to cure the resin at 26b.

An apparatus suitable for practicing the method is shown diagrammatically in FIG. 5. The apparatus may comprise of a curtain coater 27 which supplies a layer 28 of a light-curable material of uniform thickness to the surface of an endless woven base material 29, which runs around roll 30 and roll 40.

An endless mask 31 can be positioned above the woven material 29 which runs around rolls 30, 40. The lower run 32 of the mask can be spaced from the surface of the woven material 29 by an amount sufficient to accommodate the coating layer present on the woven base material surface and to provide a small clearance between such coating layer and the mask. The mask 31 is driven at exactly the same speed to that of the woven material 29, so the “laminate” of the lower run 32 of the mask 31, the woven base 29 and the coating move together.

Mask 31 is selectively transparent, such that regions are provided thereon are opaque to the radiation necessary to effect curing of the light-curable material. Further, the regions can be randomly sized, shaped and distributed in a similar like manner to that shown in FIG. 2.

An elongated ultra-violet light source 33 can be provided within the loop of endless mask 31, such that the light source 33 further includes a parabolic reflector 34 positioned as to deliver parallel ultra-violet light to the mask in a direction perpendicular thereto.

The apparatus further includes a pressure fluid applicator 35, that may include a compressed air jet positioned downstream of the mask 31. Further, an extractor 36 can be arranged in register with the pressure fluid applicator 35 and at the opposite side of the coating with respect to the pressure fluid applicator 35.

An additional curing apparatus 37 may be included downstream of the pressure fluid applicator 35, such that the radiation supplied by the curing apparatus can effect the curing of the photopolymeric material.

In one particular example of the invention, the photopolymeric material used may include a blend of acrylated esters and/or urethanes and a photo initiator. The acrylate moieties are the active centers in so far as the curing is concerned. The initiator for the free radical process is based on acetophenone. A 200 μm to 500 μm thick layer of the photopolymeric material is laid on the woven material and the mask is positioned in such a way that the lower run thereof is spaced from the surface of the material by a distance of 0 mm to 1 mm. The light source can be positioned from 500 mm to 1000 mm above the photopolymeric material, so as to provide radiation that is a dominant wavelength (Lambda max.) of 365 nm to give a partial core time of 30 seconds.

It is to be understood that the wavelengths of the ultra-violet light emitted by the source can extend over a range of between 250 nm to 400 nm, although the initiator reacts to wavelengths within a narrow band of approximately 360 nm to 370 nm. The light source can be selected in regard to the wavelengths, which effect reaction of the initiator, so as to be included in the photopolymeric material. It is to be appreciated that the method and apparatus as can allow for the production to be a continuous process, of apertured sheet material produced in a simple and economic manner. The thickness of the sheet may be varied to suit particular requirements.

In order to manufacture hydroentanglement screens of the type illustrated in FIG. 3, the polymeric material might be fed onto a support belt, wherein yarns may be fed into the mix on the support belt prior to curing said material.

It is to be understood that the above described embodiments are by way of illustration only. Many modifications and variations are possible.

1. A method of producing a screen for forming a nonwoven material by hydroentanglement, the method comprising:
irradiating at least one layer of radiation curable polymeric resin material in fluid form through at least one mask selectively transparent to the radiation so as to effect at least partial curing of the material of the at least one layer in positions corresponding with radiation-transparent regions of the mask; and
removing uncured polymeric material to form one or more apertures within the at least one layer;
wherein the radiation-transparent regions of the mask have different sizes and shapes and are distributed randomly such that the one or more apertures formed in the cured polymeric material of the screen are not provided in a regular pattern or form.

2. A method as claimed in claim 1, wherein the at least one layer is provided as a coating on a base fabric.

3. A method as claimed in claim 1, wherein the at least one layer at least partially impregnates a base fabric.

4. A method as claimed in claim 2, wherein the coating has a thickness in the range from 200 μm to 500 μm.

5. A method as claimed in claim 1, wherein a plurality of machine direction yarns extends through the screen.

6. A method of claimed in claim 5, wherein the screen has a thickness in the range from 0.8 to 1.5 mm.

7. A method as claimed in claim 1, wherein the width of each of the apertures is in the range from 100 μm to 800 μm.

8. A method as claimed in claim 1, wherein the apertures constitute from 50% to 70% of the surface area of the screen.

9. A method as claimed in claim 1, wherein the aggregate porosity of the screen per unit area is substantially the same.

10. A method as claimed in claim 1, wherein the mask comprises U.V. transparent plastics film printed with a plurality of isolated ink dots of various sizes and shapes.

11. A method as claimed in claim 1, wherein a further pattern of radiation curable material is applied and cured at the surface of the screen for forming an impression in the nonwoven material formed thereon.

12. A hydroentanglement screen for forming a nonwoven material by hydroentanglement, the screen comprising:
an array of apertures in a surface structured and arranged to support the nonwoven material, the apertures of the array being of various sizes and shapes and being distributed randomly to not be in a regular pattern.

13. A screen as claimed in claim 12, wherein the screen comprises a coating on a base fabric.

14. A screen as claimed in claim 13, wherein the coating at least partially impregnates the base fabric.

15. A screen as claimed in claim 13, wherein the coating has a thickness in the range from 200 μm to 500 μm.

16. A screen as claimed in claim 12, wherein a plurality of machine direction yarns extends through the screen.

17. A screen as claimed in claim 16, wherein the screen has a thickness in the range from 0.8 to 1.5 mm.

18. A screen as claimed in claim 12, wherein the width of each of the apertures is in the range from 100 μm to 800 μm.

19. A screen as claimed in claim 12, wherein the apertures constitute from 50% to 70% of the surface area of the screen.

20. A screen as claimed in claim 12, wherein the aggregate porosity of the screen per unit area is substantially the same.

21. A screen as claimed in claim 12, wherein a pattern of desired shapes is provided on the screen surface for forming an impression in the hydroentanglement product.

22. A screen as claimed in claim 1, wherein fully curing the at least one layer after removal on the non-cured polymeric material.

23. A method of producing a screen, the method comprising:
partially curing at least one layer of radiation curable polymeric resin material in fluid form by irradiation through at least one mask selectively transparent to the radiation;
forming apertures in the at least one layer by removing uncured polymeric material;
wherein the mask includes radiation transparent regions having different sizes and shapes that are distributed randomly so as not to be in a regular pattern or form.

24. A screen as claimed in claim 23, wherein the screen is produced on a nonwoven material formed by hydroentanglement.

25. A screen as claimed in claim 23, wherein the method does not mark a hydroentangled product with a geometrically regular pattern of lines resulting from an imprint by a woven screen, such that regular visual detectable patterns are eliminated.

26. A screen as claimed in claim 23, wherein fully curing the at least one layer after forming the apertures.
